(19) United States
(12) Patent Application Publication
(10) Pub. No.: US 2008/0037264 A1
(43) Pub. Date: Feb. 14, 2008

(54) FIXTURE LOWERING DEVICE

(76) Inventor: Craig Delane Bennett, Mooresville, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/832,199

(22) Filed: Aug. 1, 2007

Related U.S. Application Data
(60) Provisional application No. 60/821,712, filed on Aug. 8, 2006.

(51) Int. Cl. F21V 21/14

(52) U.S. Cl. 362/386; 362/404; 362/418

(57) ABSTRACT

A device for lowering a fixture mounted on a high ceiling that requires a ladder to access the fixture includes a docking mount adapted to be mounted on the fixture, a docking station adapted to receive the docking mount, and a tether operably connected to the docking station and the docking mount for raising and lowering the fixture between a fully raised operating position and a fully lowered servicing position. The docking station or the docking mount has an annular inner surface, while the other has an annular outer surface that engages the inner surface in self-aligning, mating engagement. The inner surface may be disposed at an angle with the outer surface disposed at substantially the same angle as the inner surface. The device further includes a motor rotatably coupled to a pulley attached to the tether and a controller for activating the motor to rotate the pulley.

### CROSS-REFERENCE TO RELATED APPLICATION

This application claims the benefit of U.S. Provisional Application No. 60/821,712 filed on Aug. 8, 2006.

### FIELD OF THE INVENTION

The present invention relates to the field of fixtures, such as ceiling fans, lights, chandeliers and smoke, fire and carbon monoxide detectors. More particularly, the invention is a device for lowering a fixture mounted on a high ceiling or other elevated support that requires a ladder, scaffolding or similar structure to access the fixture.

### BACKGROUND OF THE INVENTION

Fixtures, such as ceiling fans, lights, chandeliers and smoke, fire and carbon monoxide detectors are commonly mounted out of direct reach on a high ceiling or other elevated support. As a result, individuals are required to use a ladder, scaffolding or similar structure to reach a fixture in need of service, such as cleaning and/or repair. The height of ceilings in modern homes has increased, and in some instances, is twenty feet or more. This increase in ceiling height not only makes it more dangerous to clean or repair a ceiling-mounted fixture, but in some cases, renders the task nearly impossible without the help of a professional. Cleaning and repairing these high fixtures becomes an even more daunting task for the elderly, individuals with a handicap, and individuals who are afraid of heights.

Cleaning and repairing ceiling-mounted fixtures is likewise inconvenient and often dangerous in commercial and institutional buildings, such as office buildings, schools, churches, gymnasiums, etc., despite the expertise of experienced janitorial or custodial personnel. As a result, inconvenience and potential danger are present almost anytime a fixture is beyond the immediate reach of an individual attempting to clean or repair the fixture.

Although devices for lowering a fixture mounted to a ceiling or other elevated support are known, such fixture lowering devices are typically large in size relative to the fixture, difficult to operate and, in the case of electrical fixtures, do not automatically disconnect electrical power to the fixture when the fixture is moved to the lowered position for cleaning or repair. Furthermore, most such devices do not include a docking system that integrates smoothly with the fixture to provide a uniform, aesthetic appearance in the raised position.

Accordingly, there is a need for a device for lowering a fixture (referred to herein as a “fixture lowering device”) that allows an individual to clean or repair a fixture mounted on a high ceiling or other elevated structure without the inconvenience and danger associated with the use of a ladder, scaffolding or similar structure to access the fixture.

There is a more specific need for a fixture lowering device that automatically disconnects electrical power to an electrical fixture as the fixture is moved from a raised position to a lowered position.

There is also a more specific need for a fixture lowering device that includes a docking system that integrates smoothly with the fixture to provide a uniform, aesthetic appearance in the raised position.

### SUMMARY OF THE INVENTION

It is therefore an object of the invention to provide a fixture lowering device for lowering a fixture from a raised position to a lowered position at a convenient and safe height for cleaning and/or repair.

It is another object of the invention to provide a fixture lowering device that automatically disconnects electrical power to an electrical fixture when the fixture is lowered from a raised position to a lowered position.

It is yet another object of the invention to provide a fixture lowering device that integrates smoothly with the fixture to provide a uniform, aesthetic appearance in the raised position.

### BRIEF DESCRIPTION OF THE DRAWINGS

The invention may be best understood by reference to the following description in conjunction with the accompanying drawing figures in which:

FIG. 1 is a top perspective view of a fixture lowering device in accordance with the invention attached to an electrical fixture, namely a ceiling fan;

FIG. 2 is a side perspective view of the fixture lowering device and the ceiling fan of FIG. 1; and

FIG. 3 is a partial cross-sectional view of the fixture lowering device of FIG. 1.

### DETAILED DESCRIPTION OF THE INVENTION

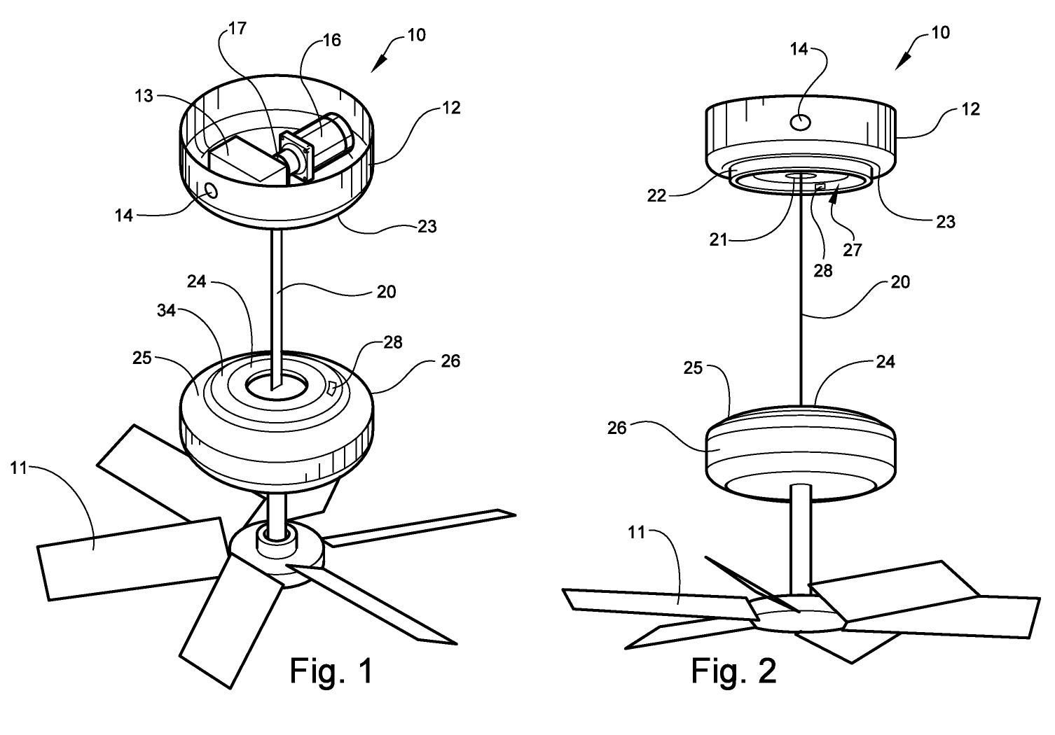

Referring now specifically to the drawing figures, a fixture lowering device according to a preferred embodiment of the invention is illustrated in FIGS. 1-3. The fixture lowering device is indicated generally by the reference numeral 10 and is shown attached to a conventional ceiling fan 11 of the type typically mounted to a high ceiling or other elevated support, for example a beam, overhang or awning. While the fixture lowering device 10 is described herein with reference to a ceiling fan 11, it should be appreciated that the device may be used with any type of mechanical or electrical fixture, such as a light (e.g. a flood light), a chandelier or a smoke, fire or carbon monoxide detector, that is positioned at a height requiring the use of a ladder, scaffolding or similar structure to clean and/or repair the fixture.

As shown, the fixture lowering device 10 includes a housing 12 that houses a controller 13 and a drive motor 16 rotatably coupled to a pulley 17, for example via a drive shaft. The controller 13 may be electrically coupled to a remote sensor 14 for operating the fixture lowering device 10 from a remote location. The housing 12 is designed to be mounted in an inverted manner to a high ceiling or other elevated support. A tether 20, such as a cable, strap, belt, rope, cord or other suitable means extends through an opening 21 formed in the underside of the housing 12, and is operably connected at one end to the motor 16 via the pulley 17. The other end of the tether 20 is directly or indirectly connected to the ceiling fan 11 to permit the motor 16 to raise and lower the ceiling fan by rotating the pulley 17, thereby winding the tether about the pulley.

The controller 13 controls the operation of the motor 16 in response to a signal from the remote sensor 14 or from an electrical switch (not shown) provided at a comfortable and safe height in a convenient location, such as on a wall or other surface. In particular, the controller 13 activates the motor 16 to rotate the pulley 17 in a conventional manner (e.g. via a drive shaft) such that the tether 20 raises and lowers the ceiling fan 11 between a fully raised position for operating the ceiling fan and a fully lowered position for servicing (e.g. cleaning and/or repairing) the ceiling fan.

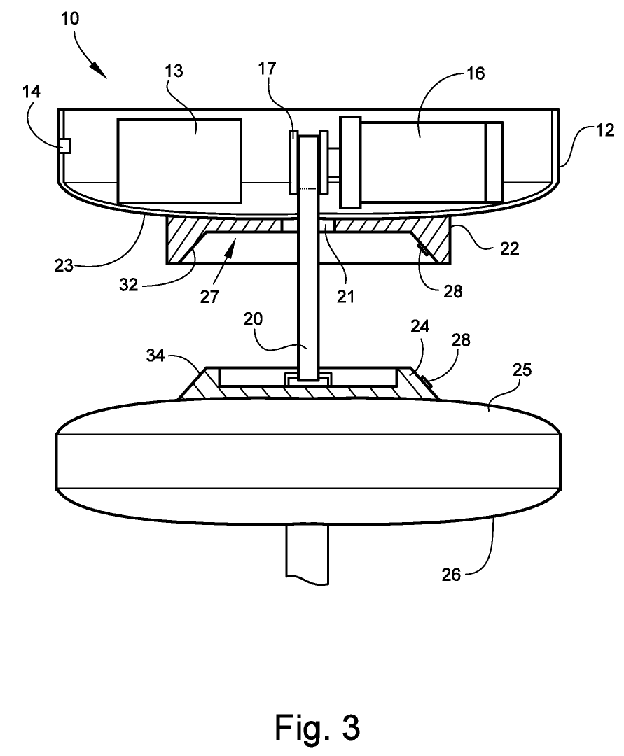

A docking station 22 is secured to a lower face 23 on the underside of the housing 12, while a cooperating docking mount 24 is secured to an upper face 25 of the housing 26 of the ceiling fan 11. As best shown in FIG. 3, the docking station 22 and the docking mount 24 are configured for self-aligning, mating engagement such that when the ceiling fan 11 is in the fully raised operating position at least a portion of the docking mount 24 is received within a recess 27 defined by the docking station 22. The docking station 22 and the docking mount 24 are adapted to allow the docking mount to automatically align and properly mate with the docking station upon raising the ceiling fan 11 to the operating position. As an added safety feature, the docking station 22 and the docking mount 24 may also include locking means (not shown) for securing the docking station and the docking mount together in the raised position. The optional locking means prevents the ceiling fan 11 from lowering unexpectedly in the event there is a failure in the motor 16, pulley 17, or tether 20.

In the particular embodiment shown in FIG. 3, the recess 27 of the docking station 22 is defined by an annular inner surface 32 that is disposed at an angle relative to the outer periphery of the docking station. The docking mount 24 has a corresponding annular outer surface 34 that is disposed at substantially the same angle as the inner surface 32 of the docking station 22. As a result, the outer surface 34 of the docking mount 24 aligns with the inner surface 32 of the docking station 22 when the docking mount is received within the docking station as the ceiling fan 11 is moved to the fully raised position. Alternatively, a recess may be formed within the docking mount 24 and the docking station 22 may be configured to be received within the recess defined by the docking mount in the same or equivalent manner. Furthermore, the inner surface 32 of the docking station 22 and the mating outer surface 34 of the docking mount 24 may have any suitable shape, for example conical (as shown), spherical, circular, rectangular or polygonal (e.g. hexagonal).

A power disconnect switch 28 is operably connected to the docking station 22, the docking mount 24, or both, for disconnecting electrical power to the ceiling fan 11 as the it is lowered from the fully raised operating position. The power disconnect switch 28 prevents the ceiling fan 11 from being inadvertently operated while it is being serviced. The power disconnect switch 28 may be any suitable type of power disconnect or interrupt device that prevents the flow of electricity (current) from a power source to the ceiling fan 11. For example, the power disconnect switch 28 may comprise a pair of electrical contacts, one on the docking station 22 and one on the docking mount 24, such that when the contacts are separated, the power source is disconnected from the ceiling fan 11. Alternatively, the power disconnect switch 28 may be a connector, having a plug portion and a receptacle portion, that is separated when the ceiling fan 11 is lowered from the fully raised position to disconnect the power source. The plug portion may be attached to the docking station 22 and the receptacle portion attached to the docking mount 24, or vice-versa. In yet another embodiment, a power disconnect switch 28 may be positioned on the docking station 22 or the docking mount 24 that is extensible between an extended position and a retracted position, such that when the ceiling fan 11 is lowered and the docking mount 24 separates from the docking station 22, the switch 28 is moved from the retracted position to the extended position to disconnect the power source from the ceiling fan.

In operation, the ceiling fan 11 is initially in a fully raised operating position with the docking station 22 and the docking mount 24 in aligned, mating engagement with each other. In this position, the power disconnect device 28 allows power to flow to the ceiling fan 11 so that normal operation of the ceiling fan can occur. When the ceiling fan 11 requires cleaning or repairing, a user transmits a signal (e.g. electrical, optical, wireless) to the controller 13 to activate the motor 16 to rotate the pulley 17 so that the ceiling fan 11 is lowered via the tether 20 to a fully lowered servicing position. The signal can be transmitted via a remote control to the remote sensor 14, by a switch electrically connected to the controller 13, or in the case of a “smart house” equipped home, by a computer.

As the motor 16 and pulley 17 lower the ceiling fan 11, the docking mount 24 separates from the docking station 22, causing the power disconnect switch 28 to disconnect the power source from the ceiling fan. Once the ceiling fan 11 has been serviced (e.g. cleaned and/or repaired), the user transmits another signal to the controller 13 that activates the motor 16 to rotate the pulley 17, thereby raising the ceiling fan back to the fully raised operating position. As the ceiling fan 11 is being raised, the docking mount 24 is received within the recess 27 and automatically aligns itself with the docking station 22. When the ceiling fan 11 is in the fully raised operating position, the docking station 22 and the docking mount 24 are in aligned, mating engagement and the power disconnect switch 28 is re-connected to allow electrical power to flow to the ceiling fan.

A fixture lowering device for lowering a mechanical or electrical fixture, such as a ceiling fan, light, chandelier, or smoke, fire or carbon monoxide detector, has been described herein. Various details of the invention may be changed without departing from its scope. Furthermore, the foregoing description of preferred embodiments of the invention and the best mode for practicing the invention are provided for the purpose of illustration only and not for purposes of limitation.

That which is claimed is:

1. A device for lowering a fixture comprising:
a first housing adapted for mounting to a ceiling or elevated support, the first housing including a docking station;
a motor disposed within the first housing;
a pulley rotatably coupled to the motor;
a second housing adapted for mounting to the fixture, the second housing including a docking mount configured to engage with the docking station; and
a tether operably connected to the pulley and to the second housing such that the fixture is moveable between a raised position and a lowered position when the motor rotates the pulley.

2. The device of claim 1, further comprising a controller disposed within the first housing for activating the motor to rotate the pulley.

3. The device of claim 2, further comprising a remoter sensor disposed on the first housing and electrically coupled to the controller.

4. The device of claim 1, wherein the docking station and the docking mount are configured for self-aligning, mating engagement when the docking mount is received within a recess defined by the docking station.

5. The device of claim 4, wherein the recess of the docking station is defined by an annular inner surface that is disposed at an angle relative to the outer periphery of the docking station and wherein the docking mount has an annular outer surface that is disposed at substantially the same angle as the inner surface of the docking station.

6. The device of claim 1, wherein the fixture is an electrical fixture and wherein at least one of the first housing and the second housing comprises a power disconnect switch for disconnecting electrical power to the fixture when the fixture is moved from the raised position.

7. The device of claim 7, wherein the power disconnect switch comprises a pair of electrical contacts disposed on the first housing and the second housing, respectively, and wherein electrical power to the fixture is disconnected when the pair of electrical contacts are separated.

8. The device of claim 1, wherein the tether is selected from the group consisting of a cable, a strap, a belt, a rope and a cord.

9. The device of claim 8, wherein an opening is formed through the first housing and the tether extends through the opening between the pulley and the second housing.

10. A fixture lowering device comprising:
a fixture;
a docking mount adapted to be mounted on the fixture;
a docking station adapted to receive the docking mount; and
a tether operably connected to the docking station and to the docking mount for raising and lowering the fixture between a fully raised operating position and a fully lowered servicing position;
wherein the docking station and the docking mount are configured for self-aligning, mating engagement when the fixture is raised to the fully raised operating position.

11. The fixture lowering device of claim 10, wherein one of the docking station and the docking mount has an annular inner surface and the other of the docking station and the docking mount has an annular outer surface that engages and mates with the inner surface to automatically align the docking station and the docking mount in the fully raised operating position.

12. The fixture lowering device of claim 11, wherein the inner surface is disposed at an angle relative to the outer periphery of the one of the docking station and the docking mount and the outer surface is disposed at substantially the same angle as the inner surface.

13. The fixture lowering device of claim 10, wherein the fixture is an electrical fixture and wherein at least one of the docking station and the docking mount comprises a power disconnect switch for disconnecting electrical power to the fixture when the fixture is moved from the fully raised operating position to the fully lowered servicing position.

14. The fixture lowering device of claim 13, wherein the power disconnect switch comprises a pair of electrical contacts disposed on the docking station and the docking mount, respectively, and wherein electrical power to the fixture is disconnected when the pair of electrical contacts are separated.

15. The fixture lowering device of claim 10, wherein the tether is selected from the group consisting of a cable, a strap, a belt, a rope and a cord.

16. The fixture lowering device of claim 10, wherein an opening is formed through the docking station and wherein the tether extends through the opening and is attached to the docking mount.

17. The fixture lowering device of claim 10, further comprising a motor disposed adjacent the docking station and a pulley rotatably coupled to the motor, the pulley operably coupled to the tether to move the fixture between the fully raised operating position and the fully lowered servicing position when the motor rotates the pulley.

18. The fixture lowering device of claim 17, further comprising a controller disposed adjacent the docking station for activating the motor to rotate the pulley.

19. The fixture lowering device of claim 18, further comprising a remote sensor electrically coupled to the controller for causing the controller to activate the motor from a remote location.

20. A method for servicing a fixture mounted on a high ceiling or an elevated support at a height that requires a ladder, scaffolding or similar structure to access the fixture, the method comprising:
providing a fixture lowering device comprising a docking station, a docking mount configured to engage the docking station in a self-aligning, mating engagement, and a tether operably connected to the docking station and to the docking mount;
mounting the fixture on the docking mount of the fixture lowering device;
extending the tether to move the fixture from a fully raised operating position to a fully lowered servicing position;
servicing the fixture in the fully lowered servicing position; and
retracting the tether to move the fixture from the fully lowered servicing position to the fully raised operating position with the docking mount being received by the docking station in self-aligning, mating engagement.
